(19) United States
(12) Patent Application Publication
(10) Pub. No.: US 2025/0061488 A1
(43) Pub. Date: Feb. 20, 2025

(54) DELIVERY AWARE AUDIENCE SEGMENTATION

(71) Applicant: ADOBE INC., SAN JOSE, CA (US)

(72) Inventors: Atanu R. Sinha, Bangalore (IN); Ryan A. Rossi, San Jose, CA (US); Sunav Choudhary, Kolkata (IN); Harshita Chopra, Delhi (IN); Paavan Indela, Hyderabad (IN); Veda Pranav Parwatala, Hyderabad (IN); Srinjayee Paul, Visakhapatnam (IN); Saurabh Mahapatra, Sunnyvale, CA (US); Aurghya Maiti, Kolkata (IN)

(21) Appl. No.: 18/451,590

(22) Filed: Aug. 17, 2023

(51) Int. Cl. G06Q 30/0251; G06N 20/00; G06Q 30/0204

(52) U.S. Cl. CPC G06Q 30/0254; G06N 20/00; G06Q 30/0204

(57) ABSTRACT

Systems and methods for delivery aware audience segmentation and subsequent delivery of content are described. Embodiments are configured to obtain activity data for a user, assign the user to a user segment based on the activity data using a machine learning model, generate a reach prediction for the user segment, select a media channel for communicating with the user based on the user segment and the reach prediction, and provide targeted content to the user via the selected media channel. According to some aspects, the machine learning model is trained based on content reach data.

### BACKGROUND

The following relates generally to machine learning, and more specifically to channel selection for content delivery. Content providers segment users into groups to deliver relevant content to similar people within each group. Audience discovery, also referred to as audience segmentation, is the process of categorizing potential customers into these distinct groups based on shared characteristics, behaviors, and preferences. Audience segmentation methods include both rule-based methods and machine learning (ML) methods that learn the importance of various user attributes for group formation. These characteristics can include demographics, user device properties, and purchasing patterns. By understanding and segmenting their audience, organizations can convey content based on the specific characteristics and preferences of each customer segment.

### SUMMARY

Systems and methods for delivery aware segmentation of audiences are described. Embodiments include a content delivery apparatus including a machine learning model with multiple sub-models. The machine learning model is configured to process user session data to generate a user embedding, predict a conversion of the user using a conversion predictor based on the user embedding, and assign the user to a cluster using a selector based on the user embedding. The machine learning model is trained user content reach data in addition, or as an alternative to user conversion data to ensure that an appropriate media channel is used to provide content to users.

A method, apparatus, non-transitory computer readable medium, and system for targeted content delivery are described. One or more aspects of the method, apparatus, non-transitory computer readable medium, and system include obtaining activity data for a user; assigning, using a selector of a machine learning model, the user to a user segment based on the activity data; generating, using a reach predictor of the machine learning model, a reach prediction for the user segment, wherein the selector and the reach predictor are trained using training data that includes content reach data; selecting a media channel for communicating with the user based on the user segment and the reach prediction; and providing content to the user via the selected media channel.

A method, apparatus, non-transitory computer readable medium, and system for targeted content delivery are described. One or more aspects of the method, apparatus, non-transitory computer readable medium, and system include obtaining training data including activity data and content reach data; generating, using a selector of a machine learning model, a provisional cluster assignment based on the activity data; computing, using a reach predictor of the machine learning model, a predicted reach based on the provisional cluster assignment; and training, using a training component, the machine learning model based on the predicted reach and the content reach data.

An apparatus, system, and method for targeted content delivery are described. One or more aspects of the apparatus, system, and method include at least one processor; at least one memory including instructions executable by the at least one processor; and a machine learning model including parameters stored in the at least one memory, where the machine learning model includes a selector configured to assign a user to a user segment and a reach predictor configured to predict content reach based on the user segment, and wherein the machine learning model is trained to assign the user to the user segment based on training data including content reach data.

### BRIEF DESCRIPTION OF THE DRAWINGS

FIG. 1 shows an example of a content delivery system according to aspects of the present disclosure.

FIG. 2 shows an example of a method for delivering content to users according to aspects of the present disclosure.

FIG. 3 shows an example of a content delivery apparatus according to aspects of the present disclosure.

FIG. 4 shows an example of a machine learning model configured to perform delivery aware audience segmentation according to aspects of the present disclosure.

FIG. 5 shows an example of media delivery using conventional segmentation versus delivery aware segmentation according to aspects of the present disclosure.

FIG. 6 shows an example of a method for providing targeted content to a user according to aspects of the present disclosure.

FIG. 7 shows an example of a method for describing first and second training phases according to aspects of the present disclosure.

FIG. 8 shows an example of a method for describing third and fourth training phases according to aspects of the present disclosure.

FIG. 9 shows an example of a method for training the machine learning model according to aspects of the present disclosure.

FIG. 10 shows an example of a computing device according to aspects of the present disclosure.

### DETAILED DESCRIPTION

The present disclosure relates to audience discovery based on content reach. Audience discovery, or audience creation, is a form of data segmentation, which refers to the process of dividing a diverse dataset into smaller, more homogenous subsets. Methods for segmentation include rule-based and machine learning (ML)-based methods. Both methods include identifying metrics or features that can be used to describe a user.

For example, user segmentation can be performed based on demographic features of the users (e.g., age, location, gender, browser type) or based on conversion data (i.e., whether the content had a desired impact). However, conventional segmentation methods do not take into account content reach. In some cases, different users have access to different media channels, and content sent using a channel that a user does not have access to is less likely to reach the user. Accordingly, when users are segmented without considering the expected reach of the content, the delivery of the content can misalign with the audiences.

Conventional segmentation based on conversion data is insufficient for selecting an appropriate media channel or for segmenting audiences accessible via similar media channels because the media channel is only one of several factors that can influence conversion. Importantly, conversion data is also influenced by the type of content. Therefore, content reach data can be useful in segmenting audiences, because content reach is an indicator of the effectiveness of a media channel for delivering content.

Accordingly, embodiments of the present disclosure include a machine learning model that is trained to optimize both predicted conversion and the predicted reach of delivered content. For example, some embodiments learn a mapping between user session a set of static characteristics which is used to predict both the conversion probability and the reach of the content. By jointly optimizing user segmentation for conversion and reach, the machine learning model of the present embodiments can preform more efficient content delivery as compared to existing audience segmentation systems. This enables content providers to target more users within an audience with their rendered content within a media channel.

In some examples, the systems described herein are deployed in connection with a social media platform. As a user interacts with the social media platform, their online activity is logged and converted into a user embedding. In some examples, the system assigns the user to a user segment, and pushes content through a channel determined by the user segment. In one example, the system places targeted content below a particular video on the social media platform. Because the system has segmented the user efficiently, the user is more likely to both view the video and see the targeted content, as well as to engage with the targeted content.

As used herein, ‘segments’, ‘audiences’, and ‘clusters’ are used interchangeably to refer to a grouping of users based on user characteristics, attributes, or behaviors. In some cases, a segment of users is represented directly using a list, or indirectly by statistical aggregates such as a centroid representing a cluster of user embeddings.

As used herein, a “reach probability” or “reach prediction” is a likelihood of a user being exposed to content via a media channel. A reach prediction can be expressed as a product of a “match rate” and an “exposure rate”. The match rate reflects a matching of a user segment to a media channel. A user is “matched” to a media channel if they can be found in the media channel, e.g., if they belong to a social media platform, if they are in a certain geographic location, etc. If a user is not matched to a media channel, then any content delivered through that media channel will not be seen by the user. An exposure rate refers to whether a user, after having been matched to the media channel, sees or clicks the content delivered through that media channel. In some examples, the “reach prediction” includes both values predicted separately, or a product of both values.

As used herein, a “media channel” refers to any communication channel through which a user can be contacted or presented with content. A media channel can be general, such as a social media platform, or can be specific, such as a set of conditions that encompass users who use the social media platform and who are located within a geographic area, who use a particular device or application, etc. In some cases, the media channel is defined by a set of static characteristics such as geographic data, device data, environment data, and the like.

As used herein, “activity data” refers to a list of actions performed by a user over a time session window interacting with a media channel. For example, activity data can include a list of web pages visited by a user, email activity, any changes made to a user account, etc. In some examples, activity data is collected or grouped based on a given time period.

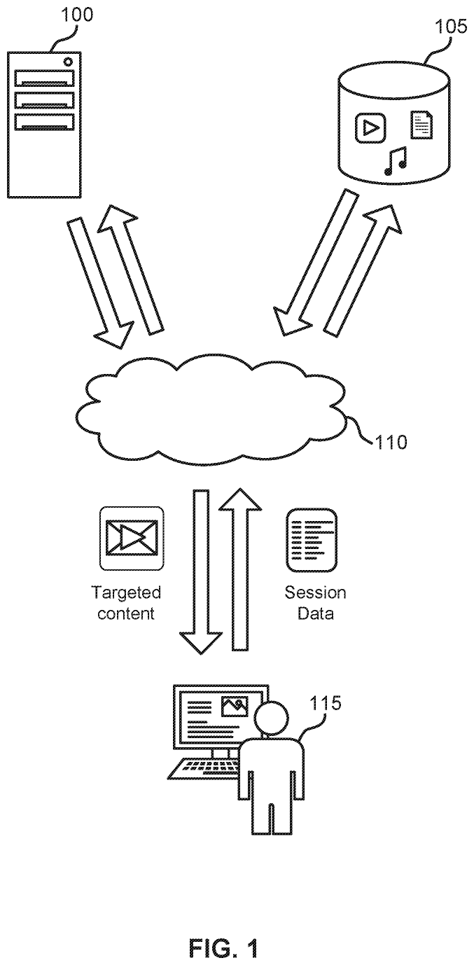

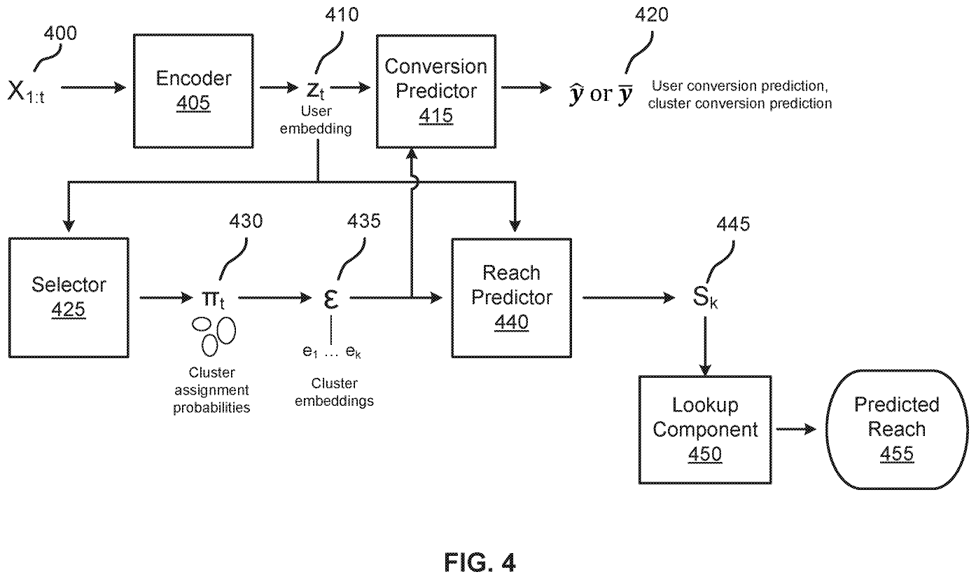

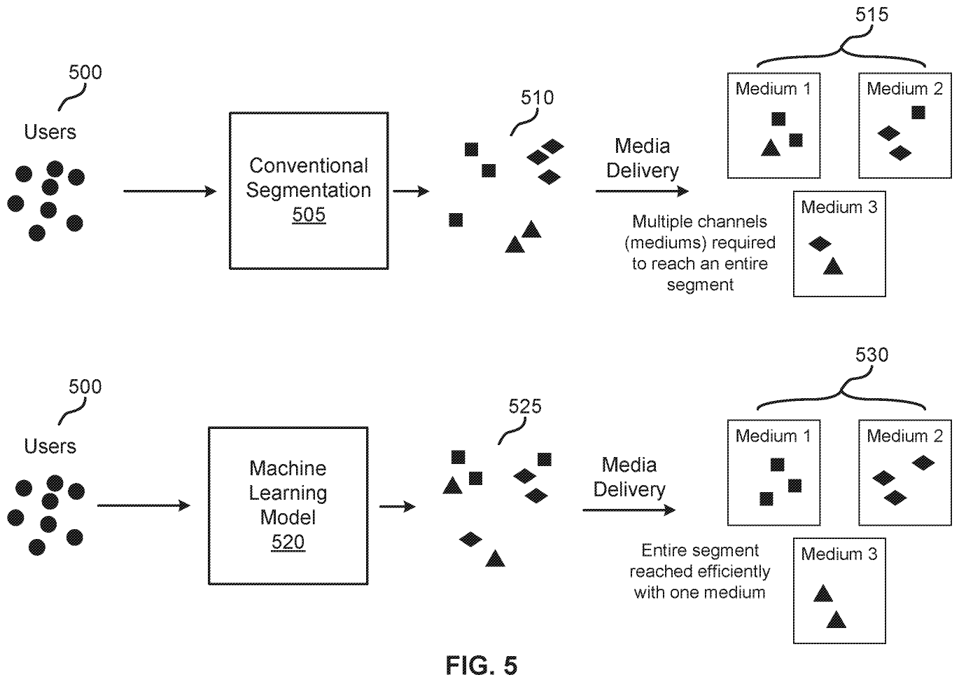

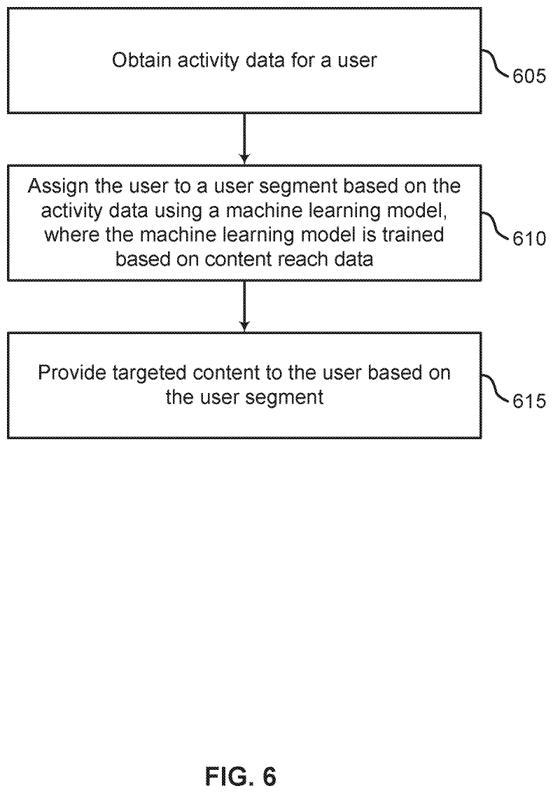

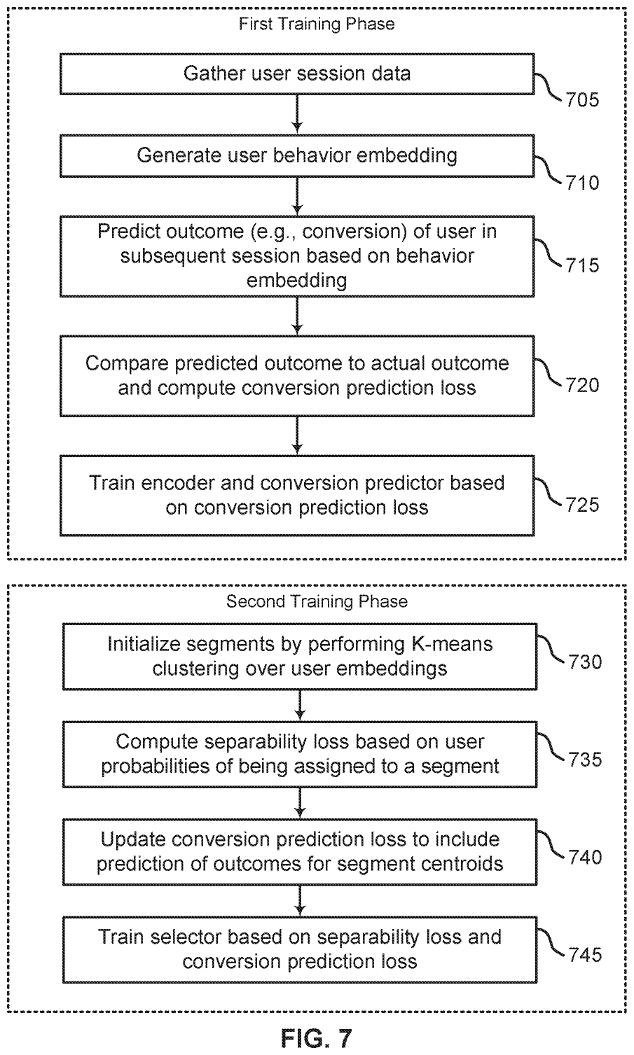

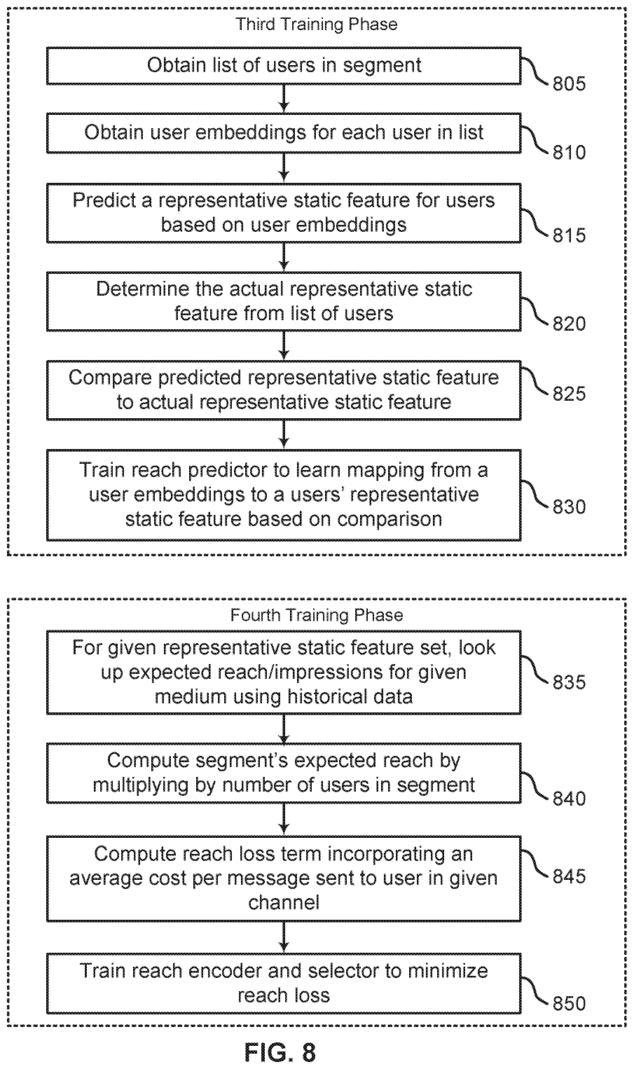

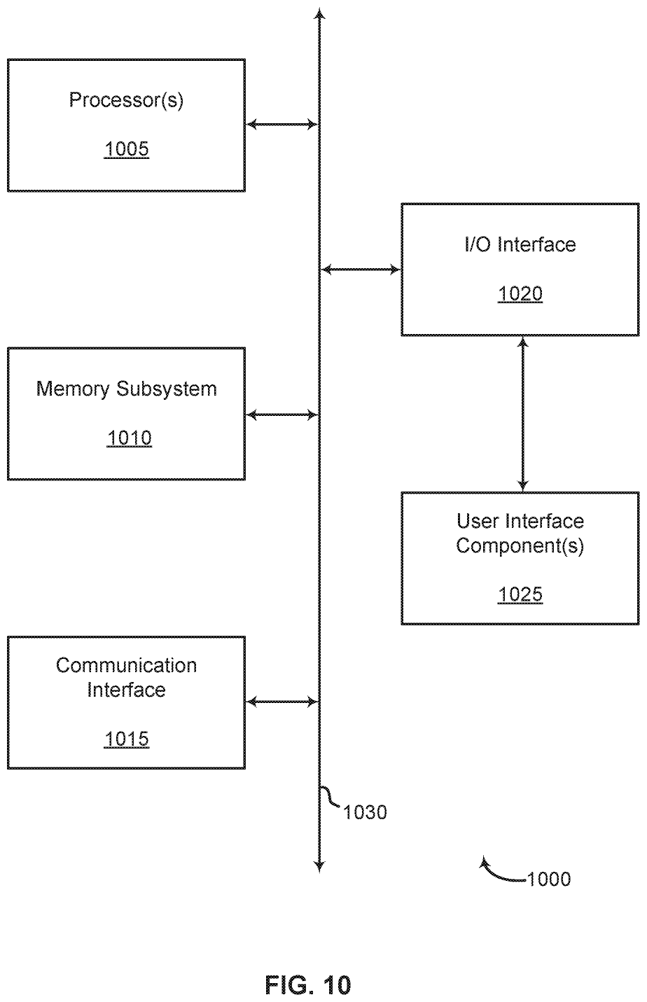

A content delivery system is described with reference to FIGS. 1-4. Specifically, FIG. 4 shows a machine learning model that includes an audience selector component that is trained jointly with both a conversion predictor and a reach predictor. An example method for targeted audience aware segmentation and content delivery is provided with reference to FIGS. 5-6. Examples of training the model are provided with reference to FIGS. 7-9. Specifically, FIG. 7 describes training based on the conversion prediction and FIG. 8 describes training based on the reach prediction. Finally, an example of a computing device configured to implement a content delivery apparatus is provided with reference to FIG. 10.

### Content Delivery System

An apparatus for targeted content delivery is described. One or more aspects of the apparatus include at least one processor; at least one memory including instructions executable by the at least one processor; and a machine learning model comprising parameters stored in the at least one memory, wherein the machine learning model comprises a selector configured to assign a user to a user segment and a reach predictor configured to predict content reach based on the user segment, and wherein the machine learning model is trained to assign the user to the user segment based on training data including content reach data.

In some aspects, the machine learning model comprises an encoder configured to generate a user embedding vector, wherein the user is assigned to the user segment based on the user embedding vector. In some aspects, the encoder comprises a hierarchical attention network. In some aspects, the selector comprises a multi-layer perceptron (MLP). In some aspects, the machine learning model comprises a conversion predictor configured to predict a conversion rate for the user. In some aspects, the conversion predictor comprises an MLP. In some aspects, the reach predictor is configured to compute a representative static feature.

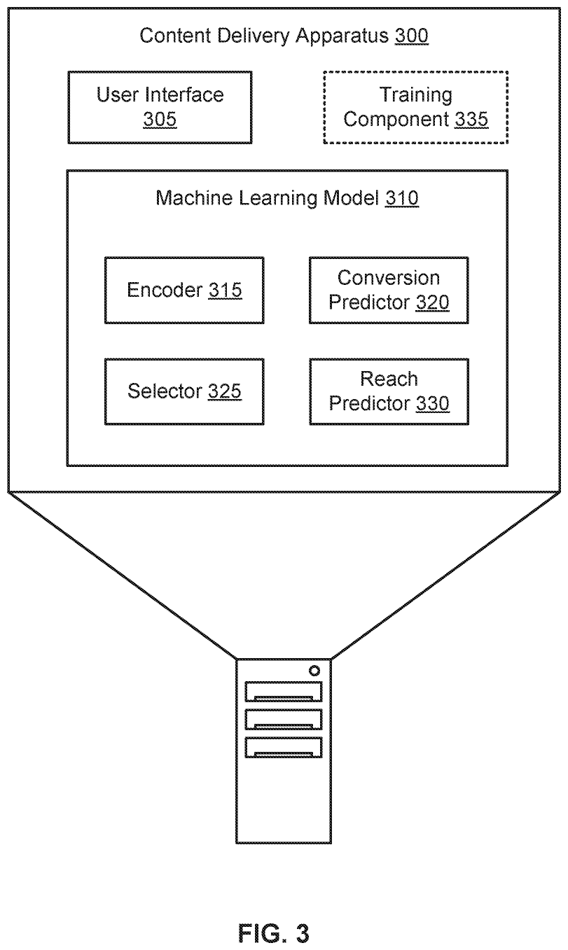

FIG. 1 shows an example of a content delivery system according to aspects of the present disclosure. The example shown includes content delivery apparatus 100, database 105, network 110, and user 115. Content delivery apparatus 100 is an example of, or includes aspects of, the corresponding element described with reference to FIG. 3.

FIG. 1 represents an overview of a content delivery system for performing user segmentation and content delivery, and illustrates an example of how content delivery apparatus 100, database 105, network 110, and user 115 interact. In an example process, content delivery apparatus 100 obtains session data from user 115. Session data includes a user's activity during a session time window, such as activity over a 24h period. In some embodiments, the session data is transferred to content delivery apparatus 100 over network 110 from a user's device or is retrieved from database 105.

A machine learning model of content delivery apparatus 100 encodes the session data to generate or update a user embedding. The machine learning model then assigns the user to a cluster using a ‘selector’ that assigns based on the user embedding. The machine learning model generates a representative static feature for the cluster the user is assigned to. Finally, content delivery apparatus 100 delivers targeted content to the user by sending the content through a media channel assigned to the cluster. An example of the media channel is a social media platform, or a mode of information transfer within the platform.

In some aspects, content delivery apparatus 100 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 is configured to store information and data used by content delivery apparatus 100. For example, database 105 is configured to store user session data, profiles, embeddings, budgets, cached API requests, machine learning model parameters, and other data. A database is an organized collection of data. For example, a database stores data in a specified format known as a schema. A database can be structured as a single database, a distributed database, multiple distributed databases, or an emergency backup database. In some cases, a database controller manages data storage and processing in database 105. In some cases, a user interacts with the database controller. In other cases, the database controller operates automatically without user interaction.

Network 110 facilitates the transfer of information between content delivery apparatus 100, database 105, and user 115. Sometimes, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User 115 interacts with content delivery apparatus 100 via a user interface of content delivery apparatus 100. In some cases, portions of the user interface are displayed on a personal machine or device of user 115.

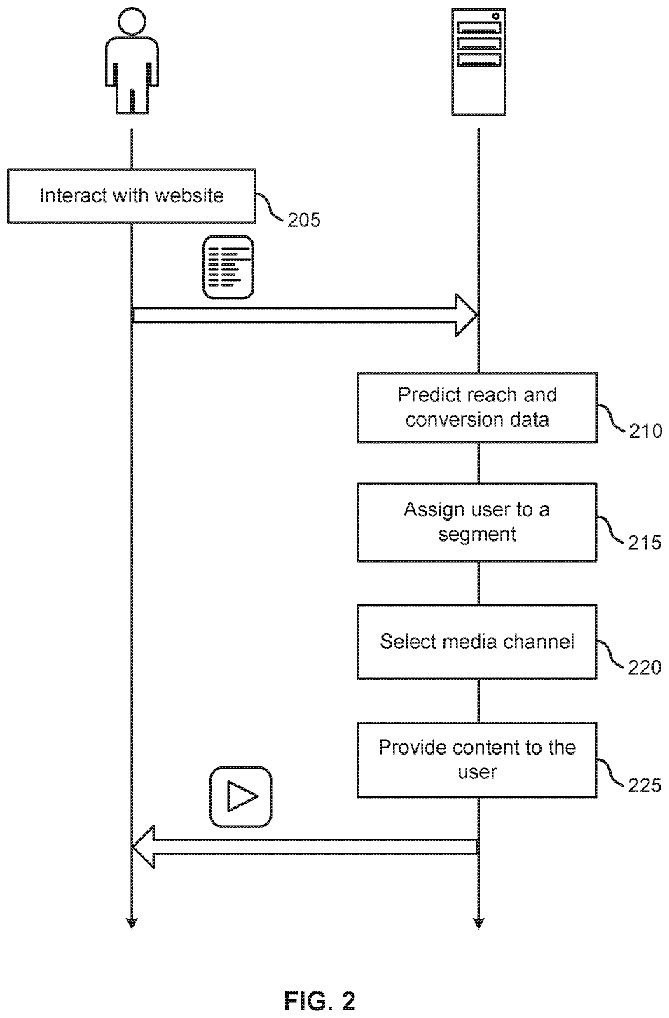

FIG. 2 shows an example of a method for delivering content to users according to aspects of the present disclosure. Specifically, FIG. 2 illustrates an example of a user interaction with a content delivery apparatus that segments users based on both reach and conversion data, such as the content delivery apparatus described with reference to FIG. 1. It includes operations performed by both a user and the content delivery apparatus. In this example, the system segments the user based on the user's interaction with a website, and provides content to the user based on the segmentation.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user interacts with a website. In some examples, the website provides an interface to a platform, such as a social media platform. According to some aspects, the system records the user's interactions as user session data. In some cases, a “session” corresponds to a time window, such as 24 hours. User session data includes, for example, the URLs of visited pages, email or message activity, or user edits to their profile.

In some examples, the system records data related to both reach data and conversion data. That is, the system records interactions that indicate whether a user interacts with content via a media channel, and whether the user performs a targeted action related to the content.

At operation 210, the system predicts reach and conversion data for the user based on the user session data. In some examples, the predicted conversion data is a value that indicates whether the user is expected to click or respond to targeted content. In some examples, the predicted reach data includes a predicted match rate of the user to a media channel and a predicted exposure rate of the user to targeted content within that media channel. The system predicts the reach and conversion data using a machine learning model in a process that will be described in additional detail with reference to FIG. 4.

At operation 215, the system assigns the user to a segment based on the user session data. In an example, the system encodes the user session data to generate a user embedding, and then processes the user embedding using a selector of the machine learning model to assign the user to a user segment. In some embodiments, the selector outputs a probability distribution for the user over a set of existing segments. According to some aspects, the selector ensures that the user belongs to a segment with high probability, and that the segment is predicted to have a high conversion rate and a high content reach.

At operation 220, the system selects a media channel for the user. In some embodiments, this operation includes predicting a representative static feature for the user segment. In some examples, the media channel is determined by the representative static feature. For example, the representative static feature can include values that define the media channel, such as a social media platform, a particular group or page within the platform, a geographic area, or similar. A reach predictor is then used to predict the representative static feature in a process that will be described in greater detail with reference to FIG. 4.

At operation 225, the system provides content to the user through the media channel. In some examples, the system delivers the content through the media channel defined by the representative static feature that corresponds to the user segment.

FIG. 3 shows an example of a content delivery apparatus 300 according to aspects of the present disclosure. The example shown includes content delivery apparatus 300, user interface 305, machine learning model 310, and training component 335. FIG. 3 illustrates an overview of the content delivery apparatus and the components contained therein. Content delivery apparatus 300 is an example of, or includes aspects of, the corresponding element described with reference to FIG. 1.

Embodiments of content delivery apparatus 300 include several components and sub-components. These components are variously named and are described so as to partition the functionality enabled by the processor(s) and the executable instructions included in the computing device used to content delivery apparatus 300 (such as the computing device described with reference to FIG. 10). In some examples, the partitions are implemented physically, such as through the use of separate circuits or processors for each component. In some examples, the partitions are implemented logically via the architecture of the code executable by the processors.

User interface 305 is configured to receive input from and display content to a user. In some examples, user interface 305 includes a graphical user interface (GUI), which is implemented within a web-based application or standalone software. Additional detail regarding user interface component(s) will be described with reference to FIG. 10.

In one aspect, machine learning model 310 includes encoder 315, conversion predictor 330, selector 335, and reach predictor 330. According to some aspects, machine learning model 310 comprises parameters stored in at least one memory, e.g. a memory subsystem, wherein the machine learning model 310 is trained to assign a user to a user segment based on content reach data. Machine learning model 310 is an example of, or includes aspects of, the corresponding element described with reference to FIG. 5.

Machine learning model 310 and its sub-components contain artificial neural networks (ANNs). The ANNs are used to generate embeddings of data, and to make classifications or predictions. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Encoder 315 is configured to process user session data to generate a user embedding. According to some aspects, encoder 315 generates a user embedding vector for the user based on the activity data, where the user is assigned to a user segment based on the user embedding vector. Embodiments of encoder 315 include a hierarchical attention network (HAN). HANs are a type of ANN that include multiple layers that each include attention mechanisms to focus on different aspects of data. In some embodiments, a first level of attention in the HAN contains activities within a session, and a second level of attention encodes session-level information using a number of session windows. Encoder 315 is an example of, or includes aspects of, the corresponding element described with reference to FIG. 4.

Conversion predictor 320 is configured to process a user embedding or a centroid embedding representing a cluster of users to predict a conversion result. Embodiments of conversion predictor include an ANN. According to some aspects, conversion predictor 320 generates a conversion prediction for the user segment, where the targeted content is provided based on the conversion prediction. According to some aspects, conversion predictor 320 computes a predicted conversion rate. Conversion predictor 320 is an example of, or includes aspects of, the corresponding element described with reference to FIG. 4.

In at least one embodiment, a HAN of encoder 315 is configured to generate a user embedding representing n session windows, and conversion predictor 320 is configured to receive the embedding and predict a result for the n+1 session of the user or the cluster centroid. In some embodiments, encoder 315 generates the embedding and the prediction.

In some aspects, the machine learning model 310 includes a selector 325 configured to assign the user to the user segment. In some aspects, the selector 325 includes a multi-layer perceptron (MLP), which is a form of ANN. Embodiments of selector 325 process the user embedding and produce a distribution over a set of clusters. In some embodiments, selector 325 samples from the cluster distribution to assign the user corresponding to the user embedding to a cluster.

According to some aspects, selector 325 assigns the user to a user segment based on the activity data using a machine learning model 310, where the machine learning model 310 is trained based on content reach data. Selector 325 is an example of, or includes aspects of, the corresponding element described with reference to FIG. 4.

In some aspects, the machine learning model 310 includes a reach predictor 330 configured to predict content reach based on the user segment. Embodiments of reach predictor 330 generate a representative static feature for the user segment. In some examples, the static characteristics included in the representative static feature determine the content reach. In an example, a lookup component obtains content reach data using, for example, one or more API requests that include information from the representative static feature. In this way, e.g., through the generation of the representative static feature, reach predictor 330 predicts the content reach to a user segment. Reach predictor 330 is an example of, or includes aspects of, the corresponding element described with reference to FIG. 4.

Training component 335 is configured to update machine learning model 310, including encoder 315, conversion predictor 320, selector 325, and reach predictor 330. According to some aspects, training component 335 obtains result data for a user or cluster of users. In some cases, the result data includes conversion result data and content reach data. Embodiments of training component 335 compute one or more loss functions, where the loss functions represent a discrepancy between the result data and prediction data. In some examples, training component 335 updates the machine learning model 310 based on the one or more loss functions.

In some examples, training component 335 trains an encoder 315 and a conversion predictor 320 of the machine learning model 310 in a first training phase. In some examples, training component 335 trains a selector 325 of the machine learning model 310 in a second training phase. In some examples, training component 335 trains a reach predictor 330 of the machine learning model 310 in a third training phase. In some examples, training component 335 trains the encoder 315 and the selector 325 in a fourth training phase. In at least one embodiment, training component 335 is provided by an apparatus other than content delivery apparatus 300.

FIG. 4 shows an example of a machine learning model configured to perform delivery aware audience segmentation according to aspects of the present disclosure. The example shown includes user session data 400, encoder 405, user embedding 410, conversion predictor 415, conversion prediction 420, selector 425, cluster assignment 430, embedding dictionary 435, reach predictor 440, representative static feature 445, lookup component 450, and predicted reach 455. Encoder 405, conversion predictor 415, selector 425, and reach predictor 440 are examples of, or include aspects of, the corresponding elements described with reference to FIG. 3. According to some aspects, the Greek letter labels used in FIG. 4 correspond to the variable labels described with reference to FIGS. 7-9.

Specifically, FIG. 4 illustrates an overview of how the machine learning model, which includes encoder 405, conversion predictor, 415, selector 425, and reach predictor 440, uses user session data 400 to predict both a conversion and a reach for a user and to assign the user to a segment based on both aspects. In an example process, encoder 405 receives user session data 400 as input, and produces an intermediate user-level representation zₜ, also referred to as user embedding 410. User embedding 410 is a representation which embodies a latent behavioral tendency of a user. In some examples, the encoder includes a hierarchical attention network (HAN). In some embodiments, a first level of attention in the HAN contains activities within a session and a second level of attention encodes session-level information using a number of session windows. In at least one embodiment, the second level attention uses two session windows.

Conversion predictor 415 receives user embedding 410 as input and predicts an outcome, e.g., conversion prediction 420. In some examples, conversion predictor 415 predicts a conversion ŷ for a user or a conversion y̅ for a cluster of users, depending on whether conversion predictor 415 processes an embedding zₜ representing a single user or an embedding e representing a cluster of users. According to some aspects, conversion predictor 415 is trained based on a comparison of the conversion prediction 420 to ground-truth conversion data, e.g., historical data. Additional detail regarding training will be provided with reference to FIGS. 7-9. In at least one embodiment, encoder 405 and conversion predictor 415 are parts of the same connected network, where encoder 405 comprises input and intermediate layers, and conversion predictor 415 comprises a classification layer.

Selector 425 also receives user embedding 410 as input. Embodiments of selector 425 are configured to generate cluster assignment 430 based on user embedding 410. In some embodiments, selector processes one or more user embeddings to generate a cluster distribution wt. In some cases, an individual user's cluster assignment sₜ is determined by selector 425 by sampling from the distribution πₜ.

Some embodiments of the machine learning model include embedding dictionary 435. Embedding dictionary 435 is a dictionary of the centroids of K clusters. In some embodiments, embedding dictionary 435 is stored as a map of key-value pairs. For example, for a given sampled cluster assignment of a user sₜ, embedding dictionary 435 outputs a centroid embedding e(sₜ) that represents the entire cluster. Some embodiments of embedding dictionary 435 also store a budget B corresponding to a cost or expected cost of media delivered to the cluster.

Reach predictor 440 receives a cluster embedding (i.e., a centroid embedding) and produces representative static feature 445 for the cluster. Then, lookup component 450 determines the predicted reach 455 to the cluster corresponding to representative static feature 445 via data lookup operation. For example, in some embodiments, a match rate of users in an i-th cluster to a j-th media channel is given by pᵢⱼ. A match rate is the proportion of the cluster that is found in the media channel. An exposure rate is the proportion of matched users in the cluster who click or interact with the media sent in the media channel, and is given by ηⱼₜ. Content reach is a measure of users who are both 1) matched in the media channel and 2) interact with the media, and is given by the product of the two rates, pᵢⱼηᵢⱼ. Lookup component 450 references a table or otherwise obtains the content reach data pᵢⱼηᵢⱼ for set of static characteristics included in representative static feature 445, such as demographics, browser/device data, or the like.

Reach predictor 440 learns a mapping between a cluster embedding, which represents behavioral data for a group of users, to a representative static feature 445, which is used to predict content reach as described above. Connecting all of the components, machine learning model learns to generate user and cluster embeddings that result in audience segmentation that both 1) maintains high conversion rates and 2) increases the accuracy of targeted media.

### Audience Aware Segmentation and Delivery

A method for targeted content delivery is described. One or more aspects of the method include obtaining activity data for a user; assigning the user to a user segment based on the activity data using a machine learning model, wherein the machine learning model is trained based on content reach data; and providing targeted content to the user based on the user segment.

Some examples of the method, apparatus, non-transitory computer readable medium, and system further include generating a conversion prediction for the user segment using the machine learning model, wherein the targeted content is provided based on the conversion prediction. Some examples further include obtaining a conversion result for the user, e.g., an individual conversion result. Some examples further include updating the machine learning model based on the individual conversion result or a segment conversion result.

Some examples of the method, apparatus, non-transitory computer readable medium, and system further include generating a reach prediction for the user segment using the machine learning model, wherein the targeted content is provided based on the reach prediction. Some examples further include selecting a media channel based on the reach prediction, wherein the targeted content is provided through the media channel.

Some examples of the method, apparatus, non-transitory computer readable medium, and system further include generating a representative static feature for the user segment, wherein the reach prediction is based on the representative static feature. Some examples further include generating a user embedding vector for the user based on the activity data, wherein the user is assigned to a user segment based on the user embedding vector.

FIG. 5 shows an example of media delivery using conventional segmentation versus an example of media delivery using delivery aware segmentation according to aspects of the present disclosure. The example shown includes users 500, conventional segmentation 505, first classified users 510, media channels including first classified users 515, machine learning model 520, second classified users 525, and media channels including second classified users 530. Machine learning model 520 is an example of, or includes aspects of, the corresponding element described with reference to FIG. 3.

FIG. 5 illustrates an example of how conventional segmentation 505 generates user segments that result in inefficient content delivery. In some cases, using convention audience segmentation methods (e.g., methods based on demographics or conversion data), a given segment (represented by different shapes such as squares or triangles) must be reached using multiple media channels. However, using a machine learning model trained for delivery aware segmentation, a single segment can be reached using a smaller number of channels (sometimes using a single channel as depicted).

FIG. 5 further illustrates an example of segmentation performed by a machine learning model according to the present embodiments, which generates segments that can be efficiently reached by each segment's assigned media channel (e.g., medium).

In a comparative example, users 500 are grouped using conventional segmentation 505. Conventional segmentation 505 groups users in a ‘discovery’ phase that does not consider media delivery. For example, some conventional techniques include a research phase to create dimensions for a user based on market research or heuristics. Then, each user is assigned to a segment based on the user's values in the dimensions. Other techniques include machine learning techniques that try to group users based on a high predicted conversion rate using embeddings, but do not consider the reach of the content when creating the embeddings.

Conventional segmentation 505 produces first classified users 510, e.g. “audiences”, which includes a set of labels for each of the users 500. However in some cases, the media is misaligned with the audiences. As shown by media channels including first classified users 515, one medium or media channel reaches only a subset of each audience, rather than having an efficient overlap with the audience. In some cases, this is due to the conventional segmentation which focused on high predicted conversion rates for individual users, and which neglected to consider the effectiveness of content delivery to the entire audience.

By contrast, users segmented using embodiments of the present disclosure such as machine learning model 520 are better aligned. For example, second classified users 525 are segmented such that the available media channels reach each of the segments with increased accuracy. In this simplified example, media channels including second classified users 530 includes a media channel for each segment that reaches the entire segment. In this way, a content provider can use a lower budget; they would not need to employ two or more media channels to reach an entire audience.

FIG. 6 shows an example of a method for providing targeted content to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains activity data for a user. In some cases, the operations of this step refer to, or are performed by, a content delivery apparatus as described with reference to FIGS. 1 and 3. In an example, the system records user session data based on a user's activity on a website.

At operation 610, the system assigns the user to a user segment based on the activity data using a machine learning model, where the machine learning model is trained based on content reach data. In some cases, the operations of this step refer to, or are performed by, a selector as described with reference to FIGS. 3 and 4. For example, an encoder of the machine learning model generates a user embedding, and the selector assigns the user based on the user embedding according to the process described with reference to FIG. 4.

At operation 615, the system provides targeted content to the user based on the user segment. In some cases, the operations of this step refer to, or are performed by, a content delivery apparatus as described with reference to FIGS. 1 and 3. In an example, a reach predictor generates a representative static feature for the user segment as described with reference to FIG. 4, and the content delivery apparatus then sends targeted content via a media channel associated with the representative static feature.

### Training

A method for targeted content delivery is described. One or more aspects of the method include obtaining training data including activity data and content reach data; generating a provisional cluster assignment based on the activity data using a machine learning model; and training the machine learning model based on the cluster assignment and the content reach data.

Some examples of the method, apparatus, non-transitory computer readable medium, and system further include computing a predicted reach based on the provisional cluster assignment. Some examples further include computing a reach loss based on the predicted reach and the content reach data, wherein the machine learning model is trained based on the reach loss. Some examples further include computing a predicted expenditure for delivering content to users represented by a set of static characteristics, and comparing the predicted expenditure to an allocated budget for a list of users in a corresponding cluster, and training the machine learning model based on this comparison.

Some examples of the method, apparatus, non-transitory computer readable medium, and system further include obtaining conversion data. Some examples further include computing a predicted conversion rate. Some examples further include computing a conversion loss based on the predicted conversion rate, wherein the machine learning model is trained based on the conversion loss.

Some examples of the method, apparatus, non-transitory computer readable medium, and system further include training an encoder and a conversion predictor of the machine learning model in a first training phase. Some examples further include training a selector of the machine learning model in a second training phase. Some examples further include training a reach predictor of the machine learning model in a third training phase. Some examples further include training the encoder and the selector in a fourth training phase.

Some examples of the method, apparatus, non-transitory computer readable medium, and system further include assigning a user to a user segment using the machine learning model. Some examples further include providing targeted content to the user based on the user segment. Some examples further include obtaining a conversion result for the user based on the targeted content. Some examples further include updating the machine learning model based on the conversion result.

Embodiments of a content delivery apparatus include a machine learning model with several subcomponents, such as the embodiments described with reference to FIGS. 3-4. In some cases, the machine learning model is trained in one or more training phases such that its subcomponents are optimized to generate embeddings and to segment users such that content delivered to the segments reaches many users in the segment, and such that the segments maintain a high conversion rate during a customer journey. In this way, embodiments jointly optimize for conversion and content reach, and provide for the efficient delivery of content.

In some embodiments, the training includes a phase for training the encoder and the conversion predictor, a phase for training the selector, a phase for training the reach predictor, and a phase for training the encoder and the selector. Though these phases are described separately, according to various embodiments, each phase can occur simultaneously with other phases, separately from the other phases, or in some combination thereof.

FIG. 7 shows an example of a method for describing first and second training phases according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

FIG. 7 illustrates an example first and second training phase. In this example, the first training phase is used to train an encoder and a conversion predictor of the machine learning model described with reference to FIGS. 3-4. This training configures the encoder to generate representations of user activity data (user embeddings) that can be effectively used by the conversion predictor to predict conversion data for a user or a user segment. In this example, the second training phase is used to train the selector of the machine learning model to effectively assign a user to a segment using the user embedding. The second training phase configures the selector to assign users to user segments in a way that ensures the segments are well separated.

At operation 705, the system gathers user session data. In some cases, a session refers to a collection of user activity over a time-window, such as 24 hours. Some embodiments collect session data for multiple sessions. In some embodiments, the machine learning model embeds two or more sessions of user activity.

At operation 710, the system generates a user behavior embedding. In an example, the system generates the user behavior embedding using an encoder, e.g., as described with reference to FIG. 4.

At operation 715, the system predicts an outcome (e.g., conversion) of the user in subsequent session based on behavior embedding. In an example, the system predicts the outcome using a conversion predictor as described with reference to FIG. 4.

At operation 720, the system compares the predicted outcome to an actual outcome and computes a conversion prediction loss. Examples of the conversion loss include the parameters in L_{1,conversion} from Equation 2.

At operation 725, the system trains the encoder and the conversion predictor based on conversion prediction loss. In some examples, a training component computes the conversion loss, and propagates a gradient based on the loss to the encoder and the conversion predictor. The training component updates parameters of the encoder and the conversion predictor based on the loss. According to some aspects, the conversion loss is initially based on a difference between a conversion prediction for an individual user and a ground-truth prediction from historical data.

At operation 730, the system initializes user segments by performing K-means clustering over user embeddings. In an example, this operation generates initial values for cluster centroids, which can then be updated by the encoder and other machine learning components over time.

At operation 735, the system computes separability loss based on user probabilities of being assigned to a segment. In some examples, this loss corresponds to L₂ described in Equation 2 and/or L₃ described in Equation 3.

At operation 740, the system updates conversion prediction loss to include prediction of outcomes for segment centroids. In some examples, the prediction loss includes a comparison between a predicted conversion of an entire user segment and a ground-truth conversion of the segment, e.g., as found in historical data.

At operation 745, the system trains the selector based on the separability loss and the conversion prediction loss. In an example, the system trains the selector using a loss based on Equation 2. In some cases, this training includes updating parameters of the selector using the training component.

According to some embodiments, the encoder and the reach predictor are trained on an input user embedding xₜ and a measured conversion output y according to the following loss:

$${ℒ}_{conversion prediction} = {x , y \sim Pxy}_{} [ - {\sum }_{t ∈ τ} {l}_{1} ( {y}_{t} , {\hat{y}}_{t} ) ] \qquad ( 1 )$$

where ŷₜ is the outcome for a user predicted by the reach predictor gϕ, e.g. ŷₜ=gϕ(f_{θ}(xₜ)). In some cases, a training component such as the one described with reference to FIG. 3 computes the losses described herein, and adjusts parameters of the machine learning model based on the losses.

Some embodiments initialize cluster embeddings by performing K-means clustering over the obtained embeddings zₜⁱ for users i over sessions t. In some aspects, the encoder and selector are trained on a sum of two losses, where the losses train the encoder and selector to produce embeddings that ensure a user belongs to a cluster with a high probability, and that result in high predicted outcome y (e.g., conversion) accuracy:

$${ℒ}_{1 , conversion} = {x , y \sim Pxy}_{} [ {\sum }_{t ∈ τ} {{s}_{t} \sim Cat ( {π}_{t} )}_{} [ {l}_{1} ( {y}_{t} , {\overline{y}}_{t} ) ] ] \\ {ℒ}_{2 , individual cluster assignment} = {x \sim Px}_{} [ - {\sum }_{t ∈ τ} {\sum }_{k ∈ K} {π}_{t} ( k ) log {π}_{t} ( k ) ] \\ {ℒ}_{encoder and selector} = {ℒ}_{1} + {αℒ}_{2} \\ {∇}_{w} {ℒ}_{encoder and selector} = {x , y \sim Pxy}_{} [ {\sum }_{t ∈ τ} {{s}_{t} \sim Cat ( {π}_{t} )}_{} [ {l}_{1} ( {y}_{t} , {\overline{y}}_{t} ) {∇}_{w} log {π}_{t} ( {s}_{t} ) ] ] + α {∇}_{w} {ℒ}_{2} \qquad ( 2 )$$

where α is a hyperparameter.

In some examples, an additional loss is computed to ensure clusters are well separated:

$${ℒ}_{3 , separation} = - {\sum }_{k \neq k ′} {l}_{1} ( {g}_{ϕ} ( e ( k ) , {g}_{ϕ} ( e ( {k}^{′} ) ) \qquad ( 3 )$$

where, in the above Equations 1-3, x are the behaviors of users as recorded in session data, πₜ are cluster assignment probabilities, sₜ is a sample from the πₜ distribution, and τ is the total time stamps for the user sessions.

FIG. 8 shows an example of a method for describing third and fourth training phases according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

FIG. 8 illustrates an example third and fourth training phase. In the example shown, the third training phase are used to configure a reach predictor to generate a representative static feature for a user segment from a user segment embedding (e.g., a centroid embedding). The representative static feature includes information that defines the media channel for the segment. Accordingly, the third training phase enables the machine learning model to match a user segment to a media channel with a high predicted reach for content sent to the user segment within the media channel. Further, in this example, the fourth training phase is used to configure the encoder and the selector to generate user embeddings and to assign users to segments, respectively, in a way that maximizes expected reach of targeted content to the user segments.

At operation 805, the system obtains a list of users in a segment. In an example, the system generates a centroid embedding that represents a segment, and assigns users to a labeled segment based on each user's embedding. The list of users can then be saved to a database.

At operation 810, the system obtains user embeddings for each user in the list. In some cases, the user embeddings are computed in a previous step, and retrieved from the database.

At operation 815, the system predicts a representative static feature for users based on user embeddings. In an example, the reach predictor predicts a representative static feature by processing the user embeddings. In some embodiments, the reach predictor predicts the representative static feature using the segment embedding (i.e., the cluster embedding) directly rather than the user embeddings.

At operation 820, the system determines the actual representative static feature from the list of users. In an example, the system identifies a set of static characteristics that align with the users in the list.

At operation 825, the system compares the predicted representative static feature to the actual representative static feature. In other words, the system predicts a representative static feature based on user embeddings or the cluster embedding, and then obtains a ground-truth representative static feature by corresponding data from the users in the list, and then compares the predicted feature to the ground-truth feature. At operation 830, the system trains the reach predictor to learn a mapping from a user or cluster's embedding to a user or cluster's representative static feature based on the comparison.

At operation 835, the system looks up expected reach for a given medium using historical data for a given representative static feature set. At operation 840, the system computes a segment's expected reach by multiplying by number of users in segment by the reach rates from the historical data.

At operation 845, the system computes a reach loss term incorporating an average cost per message sent to user in given channel. Examples of this loss includes the losses described by Equations 4 and 6.

At operation 850, the system trains encoder and the selector to minimize the reach loss. In this way, embodiments of the present disclosure learn to generate clusters that maximize an expected reach of content delivered to the cluster while maintaining a high conversion of the users in the cluster.

Accordingly, in addition to training the encoder, conversion predictor, and selector, embodiments train the reach predictor to optimize the segmentation process to produce segments that will be efficiently reached by targeted content. Some embodiments produce a per-cluster loss for cluster i as given by:

$${L}_{i} = {\sum }_{j} {{X}_{ij} ( {ρ}_{ij} {η}_{ij} - B / {Nc}_{j} )}^{2} \qquad ( 4 )$$

where Xᵢⱼ=1 when i-th cluster is assigned to j-th medium, and =0 otherwise. pᵢⱼ is the match rate of i-th cluster to j-th medium, and ηᵢⱼ is the exposure rate. The product of the two rates is the reach of the medium to the users in the cluster. B is the budget of a content provider for a given medium, and N is the number of users, and cⱼ is the cost per user reached in the medium. The propagated gradient is given by:

$${x , y \sim Pxy}_{} [ {\sum }_{t ∈ τ} {{s}_{t} \sim Cat ( {π}_{t} )}_{} [ {L}_{{s}_{i}} {∇}_{w} log {π}_{t} ( {s}_{t} ) ] ] + α {∇}_{w} {ℒ}_{2} \qquad ( 5 )$$

where Lₛ_{ₜ} is the loss of the sₜ-th cluster sample from the selector.

In addition to or alternatively to the per-cluster loss, some embodiments train the reach predictor using a single loss that is averaged across all clusters:

$$L = \frac{{\sum }_{i} {\sum }_{j} {X}_{ij} {{n}_{i} ( {ρ}_{ij} {η}_{ij} - B / {Nc}_{j} )}^{2}}{{\sum }_{i} {n}_{i}} \qquad ( 6 )$$

with the propagated gradient is given by:

$${x , y \sim Pxy}_{} [ {\sum }_{t ∈ τ} {{s}_{t} \sim Cat ( {π}_{t} )}_{} [ L {∇}_{w} log {π}_{t} ( {s}_{t} ) ] ] + α {∇}_{w} {ℒ}_{2} \qquad ( 7 )$$

Note, in some cases, embodiments optimize for ‘impressions’, rather than reach. Accordingly, such embodiments optimize according to the above equations, but only use the match rate pᵢⱼ; e.g., set ηᵢⱼ to 1.

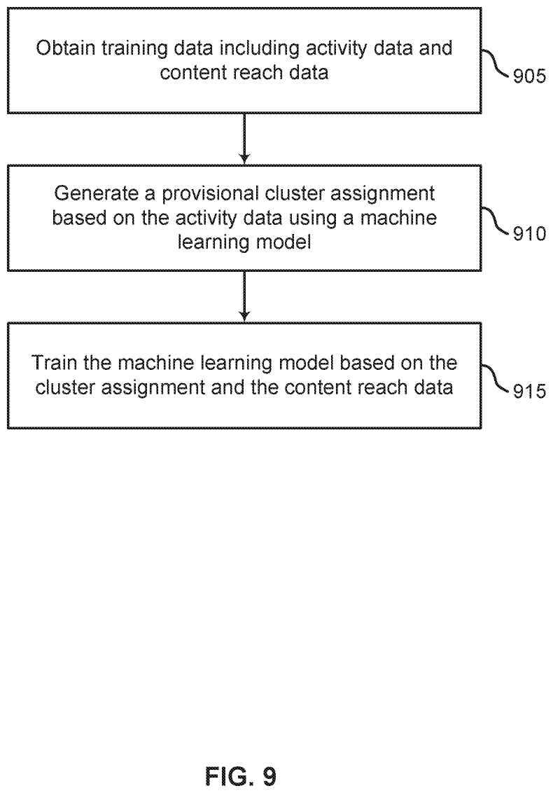

FIG. 9 shows an example of a method for training the machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

The example described with reference to FIG. 9 combines aspects of the training phases described with reference to FIG. 8 into a single training process. In this example, the machine learning model is trained to assign users to user segments (e.g., a “cluster”) in a way that maximizes content reach using ground-truth content reach data.

At operation 905, the system obtains training data including activity data and content reach data. In some cases, the operations of this step refer to, or are performed by, a content delivery apparatus as described with reference to FIG. 3. In some examples, the activity data corresponds to user sessions, and is provided through e.g., historical data from a database. The content reach data includes data that describes the reach of content to subsets of users, where the subsets are defined by various properties of the users such as demographics, geographical location, device information, etc.

At operation 910, the system generates a provisional cluster assignment based on the activity data using a machine learning model. In some cases, the operations of this step refer to, or are performed by, a selector as described with reference to FIGS. 3 and 4. According to some aspects, a “provisional” cluster assignment refers to a cluster prediction made by the selector.

At operation 915, the system trains the machine learning model based on the cluster assignment and the content reach data. In some cases, the operations of this step refer to, or are performed by, a training component as described with reference to FIG. 3. In an example, the training component updates parameters of an encoder of the machine learning model and a reach predictor of the machine learning model as described with reference to FIGS. 7-8.

FIG. 10 shows an example of a computing device 1000 according to aspects of the present disclosure. The example shown includes computing device 1000, processor(s) 1005, memory subsystem 1010, communication interface 1015, I/O interface 1020, user interface component(s), and channel 1030.

In some embodiments, computing device 1000 is an example of, or includes aspects of, content deliver apparatus 100 of FIG. 1. In some embodiments, computing device 1000 includes one or more processors 1005 that can execute instructions stored in memory subsystem 1010 to obtain activity data for a user; assign the user to a user segment based on the activity data using a machine learning model, wherein the machine learning model is trained based on content reach data; and provide targeted content to the user based on the user segment.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote control device interfaced with a user interface directly or through the I/O controller), or a combination thereof. In some cases, user interface component(s) 1025 include a GUI.

The description and drawings described herein represent example configurations and do not represent all the implementations within the scope of the claims. For example, the operations and steps can be rearranged, combined or otherwise modified. Also, structures and devices can be represented in the form of block diagrams to represent the relationship between components and avoid obscuring the described concepts. In some cases, similar components or features have the same name but might have different reference numbers corresponding to different figures.

Some modifications to the disclosure are be readily apparent to those skilled in the art, and the principles defined herein can be applied to other variations without departing from the scope of the disclosure. Thus, the disclosure is not limited to the examples and designs described herein, but is to be accorded the broadest scope consistent with the principles and novel features disclosed herein.

The described methods can be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor can be a microprocessor, a conventional processor, controller, microcontroller, or state machine. A processor can also be implemented as a combination of computing devices (e.g., a combination of a DSP and a microprocessor, multiple microprocessors, one or more microprocessors in conjunction with a DSP core, or any other such configuration). Thus, the functions described herein can be implemented in hardware or software and can be executed by a processor, firmware, or any combination thereof. If implemented in software executed by a processor, the functions can be stored in the form of instructions or code on a computer-readable medium.

Computer-readable media includes both non-transitory computer storage media and communication media including any medium that facilitates transfer of code or data. A non-transitory storage medium is any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components can be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

What is claimed is:

1. A method comprising:
obtaining activity data for a user;
assigning, using a selector of a machine learning model, the user to a user segment based on the activity data;
generating, using a reach predictor of the machine learning model, a reach prediction for the user segment, wherein the selector and the reach predictor are trained using training data that includes content reach data;
selecting a media channel for communicating with the user based on the user segment and the reach prediction; and
providing content to the user via the selected media channel.

2. The method of claim 1, further comprising:
generating, using a conversion predictor of the machine learning model, a conversion prediction for the user segment using the machine learning model, wherein the content is provided based on the conversion prediction.

3. The method of claim 2, wherein:
the training data includes the conversion data for training the conversion predictor.

4. The method of claim 1, further comprising:
generating a targeted content element based on the user segment, wherein the content includes the targeted content element.

5. The method of claim 1, wherein generating the reach prediction comprises:
generating, using the reach predictor of the machine learning model, a representative static feature for the user segment, wherein the reach prediction is based on the representative static feature.

6. The method of claim 5, further comprising:
performing a lookup based on the representative static feature to obtain the reach prediction.

7. The method of claim 1, further comprising:
selecting, using the machine learning model, a media channel based on the reach prediction, wherein the targeted content is provided through the media channel.

8. A method comprising:
obtaining training data including activity data and content reach data;
generating, using a selector of a machine learning model, a provisional cluster assignment based on the activity data;
computing, using a reach predictor of the machine learning model, a predicted reach based on the provisional cluster assignment; and
training, using a training component, the machine learning model based on the predicted reach and the content reach data.

9. The method of claim 8, further comprising:
computing, using the training component, a reach loss based on the predicted reach and the content reach data, wherein the machine learning model is trained based on the reach loss.

10. The method of claim 8, further comprising:
obtaining conversion data;
computing, using a conversion predictor of the machine learning model, a predicted conversion rate; and
computing, using the training component, a conversion loss based on the predicted conversion rate, wherein the machine learning model is trained based on the conversion loss.

11. The method of claim 8, further comprising:
training an encoder and a conversion predictor of the machine learning model in a first training phase;
training the selector of the machine learning model in a second training phase;
training a reach predictor of the machine learning model in a third training phase; and
training the encoder and the selector in a fourth training phase.

12. The method of claim 8, further comprising:
assigning, using the selector of the machine learning model, a user to a user segment;
providing, via a user interface, targeted content to the user based on the user segment;
obtaining, using a conversion predictor of the machine learning model, a conversion result for the user based on the targeted content; and
updating, using a training component, the machine learning model based on the conversion result.

13. An apparatus comprising:
at least one processor;
at least one memory including instructions executable by the at least one processor; and
a machine learning model comprising parameters stored in the at least one memory, wherein the machine learning model comprises a selector configured to assign a user to a user segment and a reach predictor configured to predict content reach based on the user segment, and wherein the machine learning model is trained to assign the user to the user segment based on training data including content reach data.

14. The apparatus of claim 13, wherein:
the machine learning model comprises an encoder configured to generate a user embedding vector, wherein the user is assigned to the user segment based on the user embedding vector.

15. The apparatus of claim 14, wherein:
the encoder comprises a hierarchical attention network.

16. The apparatus of claim 14, wherein:
the reach predictor takes the user embedding vector and the user segment as input.

17. The apparatus of claim 16, wherein:
the selector comprises a multi-layer perceptron (MLP).

18. The apparatus of claim 13, wherein:
the machine learning model comprises a conversion predictor configured to predict a conversion rate for the user.

19. The apparatus of claim 18, wherein:
the conversion predictor comprises an MLP.

20. The apparatus of claim 18, wherein:
the conversion predictor is configured to generate a user conversion prediction, a segment conversion prediction, or both.
